(19) United States
(12) Patent Application Publication
(10) Pub. No.: US 2025/0350363 A1
(43) Pub. Date: Nov. 13, 2025

(54) Optical Transceiver

(71) Applicant: Nippon Telegraph and Telephone Corporation, Tokyo (JP)

(72) Inventors: Osamu Moriwaki, Bunkyo-ku, Tokyo (JP); Kenya Suzuki, Bunkyo-ku, Tokyo (JP)

(21) Appl. No.: 18/869,734

(22) PCT Filed: May 31, 2022
(86) PCT No.: PCT/JP2022/022128

§ 371 Date: Nov. 26, 2024

(51) Int. Cl. H04B 10/40; H04B 10/67; H04Q 11/00

(52) U.S. Cl. CPC H04B 10/40; H04B 10/67; H04Q 11/0005; H04Q 2011/0007

(57) ABSTRACT

An optical transceiver includes an optical transmission unit and an optical reception unit and constitutes a network. The optical transmission unit transmits data at a symbol rate common in the network. The optical transceiver includes: an N-input-1-output optical switch that switches an optical signal received by the optical reception unit; a 1-input-N-output optical switch provided upstream of the optical signal with respect to the optical switch; and N delay lines of different lengths connected between the optical switch and the optical switch, and the optical signal input to the optical switch is input to the optical switch through one of the optical waveguides and received by the optical reception unit.

### TECHNICAL FIELD

The present disclosure relates to an optical transceiver that transmits and receives an optical signal.

### BACKGROUND ART

With the spread of the Internet, the demand for data communication networks is rapidly increasing. In order to cope with rapidly increasing demand, optical communication networks capable of transmitting large capacity data with low power consumption have been widely constructed. In an optical communication network, a technology utilizing an optical switch that flexibly sets a combination of transceivers and intermediate paths, such as a Colorless, Directionless, Contentionless Reconfigurable Optical Add Drop Multiplexer (CDC-ROADM) technology, has already been put into practical use, and is used mainly in a long-distance network. In addition, in order to efficiently use a network utilizing an optical switch in a relatively short-distance network such as that in a campus or an office building, research and development of a technology for shortening a transient response time of a device used for an optical switch or a transceiver is in progress. Such a technology is disclosed in Patent Literature 1 and Non Patent Literature 1, for example.

### CITATION LIST

### Patent Literature

Patent Literature 1: WO/2021/149243 A

### Non Patent Literature

Non Patent Literature 1: Kenya Suzuki, Kazushige Yonenaga, Noboru Takachio, Toshiki Tanaka, Osamu Moriwaki, and Hiroshi Onaka: “Device Response Time Reduction for Large-Scale and Fast Optical Switching Systems,” Optical Fiber Communication Conference (OFC), Paper Tu6A.6 (2021).

### SUMMARY OF INVENTION

In an optical communication network, if a transient response time of a device used in an optical switch, a transceiver, and the like can be shortened to shorten a non-operating time associated with a path change, a ratio of the non-operating time can be kept low even if the path is changed frequently, and the utilization efficiency of the network can be improved. However, the non-operating time due to the path change is not determined only by the transient response time of the device, and the time required to operate at the correct time interval (frequency) and timing (phase) for reading data in the receiver is also included.

When optical signals propagated through paths of different lengths are received from different transmitters along with the path change, time intervals (frequencies) of data transmitted by the transmitters may be different. In such a case, the receiver needs to adjust a time interval (frequency) at which data is read to the reception signal each time the path is changed. Even when time intervals (frequencies) of data transmitted by the transmitters are the same, timings at which the transmitters transmit data are different, and paths of different lengths are propagated. Therefore, the receiver needs to adjust a timing (phase) at which data is read to a reception signal each time the path is changed. There is a problem that it takes a long time to adjust a time interval (frequency) and timing (phase) at which data is read to the reception signal, and it is not possible to shorten the non-operating time associated with the path change.

An aspect of the present disclosure has been made in view of the above points, and relates to an optical transceiver that shortens a time required to adjust a time interval and a timing for reading data to a reception signal at the time of a path change in a network, and thus has a short non-operating time associated with the path change.

In order to achieve the above object, an optical transceiver according to an aspect of the present disclosure includes an optical transmission unit and an optical reception unit and constituting a network, in which the optical transmission unit transmits a data signal at a symbol rate common in the network and the optical transceiver includes: an N-input-1-output first optical switch that switches an optical signal received by the optical reception unit; a 1-input-N-output second optical switch provided upstream of the optical signal with respect to the first optical switch; and N optical waveguides of different lengths connected between the first optical switch and the second optical switch, and the optical signal input to the second optical switch is input to the second optical switch through one of the optical waveguides and received by the optical reception unit.

According to the aspect described above, it is possible to provide an optical transceiver that shortens a time required to adjust a time interval and a timing for reading data to a reception signal at the time of a path change in a network, and thus has a short non-operating time associated with the path change.

### BRIEF DESCRIPTION OF DRAWINGS

FIG. 1 is a diagram for explaining an optical transceiver according to an embodiment of the present disclosure, and is a top view of the optical transceiver.

### DESCRIPTION OF EMBODIMENTS

Hereinafter, one embodiment of the present disclosure will be described. The drawings used for the description in the present embodiment are for describing the configuration, the arrangement of each unit, the operation, the function, and the technical idea of the present disclosure, and do not limit the specific shape of the optical transceiver of the present disclosure, and do not necessarily accurately represent the aspect ratio and the thickness thereof.

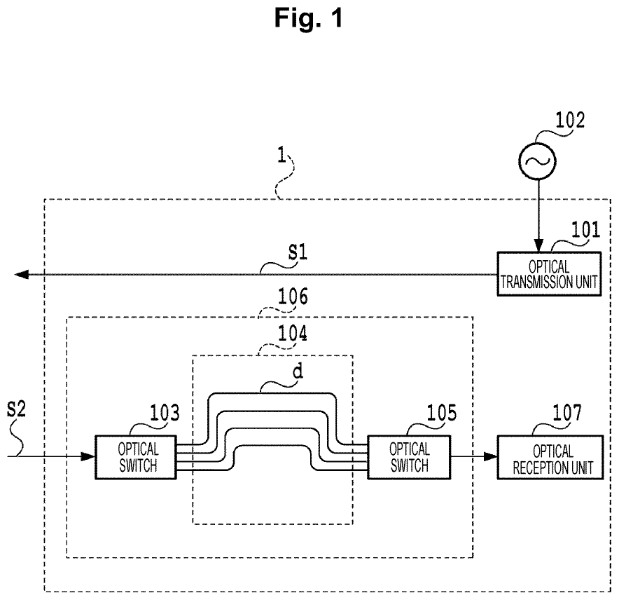

FIG. 1 is a diagram for explaining an optical transceiver 1 according to the present embodiment, and is a top view of the optical transceiver 1. In the present embodiment, a plurality of optical transceivers 1 constitute a network in which signals including data signals are transmitted and received in a wired manner. Here, the present disclosure will be described by taking a communication system of an optical network including the plurality of optical transceivers 1 as an example. The data signal refers to a signal including information desired to be transmitted, excluding a control signal, among signals transmitted and received by the optical network system. The optical transceiver 1 includes, for example, a circuit manufactured on a silicon substrate by a planar lightwave circuit technology made of quartz-based glass containing SiO₂ as a main component. The optical transceiver 1 includes an optical transmission unit 101 and an optical reception unit 107, and has both functions of transmitting and receiving an optical signal. The optical transceiver 1 includes optical switches 103, 105, and the optical switches 103, 105 are waveguide-type optical switches manufactured by planar lightwave circuit technology, and are driven by using a thermo-optic effect.

Optical switches using the thermo-optic (TO) effect are highly reliable because they do not have moving parts like mechanical switches. In addition, since the temperature that causes the refractive index change is a scalar quantity, polarization dependence is small as compared with optical switches using an electro-optical effect that changes the refractive index by the electric field of the vector quantity or optical switches using liquid crystal. Although the thermo-optical switch can be achieved using various materials, the thermo-optical switch using the planar lightwave circuit is excellent in that 1) the silica-based glass of the optical waveguide material is excellent in physical and chemical stability, 2) the connection loss with the optical fiber is low, 3) the switch element can be integrated at a high density, and integration with other optical circuit elements such as a wavelength multiplexer/demultiplexer and a branching circuit is also possible, and 4) a plurality of chips can be collectively manufactured in a wafer, so that it is suitable for mass production. In addition, the response speed of the thermo-optical switch is about millisecond because the response speed is limited by thermal conduction, but the response speed is sufficient for path switching in a current optical fiber communication network.

The optical switch 103 and the optical switch 105 are connected by a delay line bundle 104 including a delay line d which is a plurality of (N) optical waveguides. N is an integer of 2 or more. The optical switches 103, 105 and the optical reception unit 107 constitute an optical circuit 106. Such an optical circuit 106 can be manufactured as a quartz-based planar lightwave circuit device using, for example, the technology disclosed in Patent Literature 1.

The example of the first embodiment illustrated in FIG. 1 illustrates an optical transceiver 1 including N=4, that is, four delay lines d. N may be 2 or more, and is not limited to 4.

Next, each of the above components will be described. The optical transmission unit 101 receives a clock signal from a system clock 102 and transmits an optical signal S1 at a symbol rate synchronized with the clock signal. The clock signal is a common synchronization signal used in the entire network system including the optical transceiver 1.

The optical switch 103 is a 1-input N-output switch. The optical switch 103 receives an optical signal S2 and outputs the optical signal S2 to one of the four delay lines d. The optical switch 105 is a 4-input 1-output switch. The optical switch 105 receives the optical signal S2 from the four delay lines d and outputs the optical signal S2 to the optical reception unit 107. The optical switch 103 and the optical switch 105 are desirably switched in a time equal to or shorter than a transient response time of an optical switch (not illustrated) that switches a path of an optical signal in a system of a communication network in which the optical transceiver 1 includes the optical signal.

The four delay lines d included in the delay line bundle 104 are optical waveguides, and all have different lengths. Due to the difference in the length of the delay lines d, the timings at which signals passing through the delay lines reach the optical reception unit 107 via the optical switch 105 are different. In the present embodiment, when the path change is performed in the optical communication network, the optical switch 103 selects one of the delay lines d of different lengths in accordance with the optimum timing of reading the signal, and outputs the signal. Therefore, in the present embodiment, it is not necessary to adjust the timing of reading data to the reception signal every time the optical reception unit 107 changes the path, and it is possible to shorten the non-operating time due to the path change.

That is, the path change of the optical communication network may cause the timing at which a signal reaches the optical switch 103 to be earlier or later. In such a case, a shift occurs before and after the path change at an appropriate timing at which the optical reception unit 107 reads a signal. In the present embodiment, by changing the delay line d from which the optical switch 103 outputs a signal to a shorter or longer delay line d, it is possible to perform reception without changing the timing at which the optical reception unit 107 reads a signal. The delay line d selected by the change is determined according to a difference in timing between before and after the path change. For example, when the timing at which the signal reaches the optical switch 103 is delayed, the delay line d is changed so that the delay line d from which the signal is output becomes shorter. For example, when the timing at which the signal reaches the optical switch 103 is advanced, the delay line d is changed so that the delay line d from which the signal is output becomes longer.

In the present embodiment, the length of the shortest delay line d among the four delay lines d is Ld1, the length of the second shortest delay line d is Ld2, the length of the second shortest delay line d is Ld3, and the length of the longest delay line d is Ld4. In such a case, when Ld2=Ld1+ΔL, Ld3=Ld1+2ΔL, and Ld4=Ld1+3ΔL hold, better performance is obtained. That is, the length of the delay line d is designed to be different by ΔL, which is a constant length, and the length of ΔL matches 1/the symbol rate at which the optical transmission unit 101 transmits data/4(=N), that is, the length at which the optical signal S2 propagates through the delay line d in ¼ (1/N) of the cycle of reading data in the receiver. When all the optical transceivers of the communication network are configured by the optical transceivers 1, all the signals are synchronized with a common clock, and a common symbol rate is used in the system. Therefore, in the present embodiment, even when a path change is performed in the optical communication network, it is not necessary to change a time interval (frequency) at which data is read, and the same setting can be maintained before and after the change.

The timing (phase) at which data is optimally read changes by changing the path. In order to optimize this timing, an optimal timing according to the path may be measured in advance, and a relationship between the path and the delay line d to be selected may be acquired. Then, the optical switch 103 may be set to select an appropriate delay line d on the basis of such a relationship. In this way, even when the path is changed in the optical communication network, it is not necessary to change the timing (phase) at which the optical reception unit 107 reads data. Therefore, in the present embodiment, in the optical communication network in which all the optical transceivers include the optical transceiver 1 of the present invention, it is possible to shorten the time required to adjust the time interval (frequency) and the timing (phase) for reading data at the time of path change to the reception signal, and to shorten the non-operating time.

The disclosure described in detail above is not limited to the present embodiment, and includes design changes and the like without departing from the gist of the present invention. In particular, the number of delay lines d between the optical switches 103 and 105 is not limited to four illustrated in FIG. 1, and may be plural. As the number of delay lines d is larger, the timing at which the signal reaches the optical switch 105 can be adjusted with higher accuracy to match the signal reading timing.

### REFERENCE SIGNS LIST

1 Optical transceiver
101 Optical transmission unit
102 System clock
103 Optical switch
104 Delay line bundle
105 Optical switch
106 Optical circuit
107 Optical reception unit

1. An optical transceiver comprising an optical transmission unit and an optical reception unit and constituting a network,
wherein the optical transmission unit transmits a data signal at a symbol rate common in the network,
the optical transceiver comprises:
an N-input-1-output first optical switch that switches an optical signal received by the optical reception unit;
a 1-input-N-output second optical switch provided upstream of the optical signal with respect to the first optical switch; and
N optical waveguides of different lengths connected between the first optical switch and the second optical switch, and
the optical signal input to the second optical switch is input to the first optical switch through one of the optical waveguides and received by the optical reception unit.

2. The optical transceiver according to claim 1, wherein the first optical switch and the second optical switch operate with a transient response time same as or shorter than a transient response time of an optical switch used to change a propagation path of the optical signal in the network.

3. The optical transceiver according to claim 1, wherein, among the N optical waveguides of different lengths, a shortest optical waveguide having a shortest length and other optical waveguides have different lengths by n×ΔL (n is a natural number), and a time required for the optical signal input to the second optical switch to propagate by ΔL through the optical waveguide is equal to a time
$$\frac{1 / symbol rate}{N}$$
obtained by dividing the reciprocal number of the symbol rate by the N.

4. The optical transceiver according to claim 1, wherein the first optical switch and the second optical switch are waveguide-type optical switches formed on a silicon substrate and manufactured by a planar lightwave circuit technology made of silica-based glass containing SiO₂ as a main component, and are driven by using a thermo-optical effect.
